(19) United States
(12) Patent Application Publication
(10) Pub. No.: US 2019/0235435 A1
(43) Pub. Date: Aug. 1, 2019

(54) SHEET DISTINGUISHING DEVICE AND IMAGE FORMING DEVICE

(71) Applicant: KONICA MINOLTA, INC., Tokyo (JP)

(72) Inventor: Akira YAMAMURA, Toyokawa-shi (JP)

(21) Appl. No.: 16/258,998

(22) Filed: Jan. 28, 2019

(30) Foreign Application Priority Data
Jan. 31, 2018 (JP) 2018-014956

(51) Int. Cl. G03G 15/00

(52) U.S. Cl. CPC G03G 15/6591; G03G 15/5029; G03G 2215/00341; G03G 2215/00751; G03G 2215/00738; G03G 15/70

(57) ABSTRACT

A sheet distinguishing device that determines sheet type and includes a light emitter, a light receiver, a calculator 53, and a determiner 52. The light emitter irradiates a sheet with light at discrete wavelengths. The light receiver receives light from the sheet. The calculator 53 obtains an intensity of light for each of the discrete wavelengths from the light received, and calculates a characteristic value with respect to a wavelength distribution of light intensity, based on the intensities obtained. The determiner 52 determines whether the sheet is a first type or a second type by using the characteristic value.

### CROSS REFERENCE TO RELATED APPLICATION

The present application claims priority under 35 U.S.C. § 119 to Japanese Patent Application No. 2018-014956 filed Jan. 31, 2018, the contents of which are hereby incorporated herein by reference in their entirety.

### BACKGROUND

### Technical Field

The present disclosure relates to technology for determining sheet type, and in particular to technology for distinguishing between coated paper and uncoated paper.

### Background Art

In an electrophotographic image forming device, it is advantageous to adjust image forming conditions according to sheet properties, and for a user to adjust settings like sheet thickness and sheet type, in order to avoid jams, image quality deterioration, defective image fixing, and the like.

However, users commonly do not accurately grasp sheet properties, and it is burdensome for users to have to investigate and correctly set sheet properties.

In order to automatically determine sheet type without making a user set a sheet type manually, conventionally, for example, a sheet is irradiated by light to detect specular reflection of light, and according to a ratio of an amount of specular reflection light to total emitted light (specular reflectance), roughness of a sheet surface is classified and sheet type is determined.

Further, according to JP 2001-194301 (A), a paper or synthetic resin sheet is irradiated with near infrared rays, and quality of the sheet is measured by using transmitted light. A sheet quality measuring device irradiates a sheet with near infrared rays in a wavelength range from 0.8 μm to 2.6 μm, receives near infrared rays transmitted through the sheet, and performs a spectral analysis in five wavelength bands 1.8 μm, 1.9 μm, 2.1 μm, 2.3 μm, and 2.4 μm. The wavelength 1.9 μm is a wavelength which moisture absorbs, and the wavelength 2.1 μm is a wavelength which cellulose absorbs. The wavelength 2.3 μm is a wavelength which ash content (inorganic filler) absorbs, and the wavelength 2.4 μm is a wavelength which coating material absorbs. Thus, by using a peak wavelength at which near infrared rays are absorbed, amounts of moisture, cellulose, ash content, and coating material of a sheet is calculated. In this way, sheet quality is measured.

There is a technical problem with using a method of determining sheet type by using specular reflectance, in that because a difference in specular reflection light amounts between matte paper coated with matte coating and uncoated paper is negligible, accuracy of discrimination between matte paper and uncoated paper is low.

Further, there is a technical problem of increased costs. When distinguishing between coated paper and uncoated paper by using a peak wavelength at which near infrared rays are absorbed to determine sheet type, a peak wavelength of light absorbed is different for different coating materials, and therefore a sensor is required that can detects absorption wavelengths for a variety of kinds of coating material, leading to increased costs.

In view of such technical problems, the present disclosure has an aim of providing description of a sheet distinguishing device that can determine whether a sheet type is coated paper or uncoated paper, and an image forming device equipped with the sheet distinguishing device.

A sheet distinguishing device reflecting at least one aspect of the present disclosure is a sheet distinguishing device that determines sheet type, comprising: a light emitter that irradiates a sheet with light at discrete wavelengths; a light receiver that receives light from the sheet; a calculator that obtains an intensity of light for each of the discrete wavelengths from the light received, and calculates a characteristic value with respect to a wavelength distribution of light intensity, based on the intensities obtained; and a determiner that determines whether the sheet is a first type or a second type by using the characteristic value.

According to this configuration, an outstanding technical effect is achieved of determining whether a sheet is coated paper or uncoated paper at low cost.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the disclosure. In the drawings:

FIG. 1A is a graph illustrating a wavelength distribution of transmittance of light obtained by irradiating four types of uncoated paper with light in a wavelength band between 400 nm and 2000 nm; and FIG. 1B is a graph illustrating a wavelength distribution of transmittance of light obtained by irradiating four types of coated paper with light in a wavelength band between 400 nm and 2000 nm.

FIG. 2 is a graph illustrating ratios of light transmittance at a wavelength of 780 nm and light transmittance at a wavelength of 1100 nm for four types of uncoated paper and four types of coated paper.

FIG. 3 is a schematic cross-section illustrating configuration of an image forming device 1 as Embodiment 1 of the present disclosure.

FIG. 4 is a block diagram illustrating configuration of a main controller 24 of a printer 2.

FIG. 5 is a diagram illustrating configuration of a sensor unit 30 of a sheet distinguishing device 3.

FIG. 6 is a block diagram illustrating configuration of a main controller 50 of the sheet distinguishing device 3.

FIG. 7 is a flowchart illustrating operations of the sheet distinguishing device 3.

FIG. 8 is a diagram illustrating a configuration of a sensor unit 30a of the sheet distinguishing device 3 according to Modification (1).

FIG. 9 is a diagram illustrating a configuration of a sensor unit 30b of the sheet distinguishing device 3 according to Modification (2).

FIG. 10 is a flowchart illustrating operations of the main controller 50 of the sheet distinguishing device 3 including the sensor unit 30b. The flowchart links to FIG. 11.

FIG. 11 is a flowchart illustrating operations of the main controller 50 of the sheet distinguishing device 3 including the sensor unit 30b. The flowchart links to FIG. 10.

FIG. 12 is a graph illustrating ratios of light transmittance at a wavelength of 780 nm and light transmittance at a wavelength of 1100 nm for four types of uncoated paper and four types of coated paper with known grammage.

FIG. 13 is a scatter diagram illustrating a relationship between grammage and ratio for the four types of uncoated paper indicated in FIG. 12.

FIG. 14 is a scatter diagram illustrating a relationship between grammage and ratio for the four types of coated paper indicated in FIG. 12.

FIG. 15 is a graph illustrating slopes of transmittance curves between wavelength 780 nm and wavelength 1100 nm illustrating a wavelength distribution of transmittance of light obtained from light in a wavelength band between 400 nm and 2000 nm irradiated on four types of uncoated paper and four types of coated paper of known grammage.

FIG. 16 is a scatter diagram illustrating a relationship between grammage and transmittance curve slope for the four types of uncoated paper indicated in FIG. 15.

FIG. 17 is a scatter diagram illustrating a relationship between grammage and transmittance curve slope for the four types of coated paper indicated in FIG. 15.

FIG. 18 is a table illustrating an example of a data structure of a correction table 201 for correcting slopes of Modification (4).

FIG. 19 is a graph illustrating a relationship between corrected slope and grammage for Modification (4).

FIG. 20 is a flowchart illustrating operations of the main controller 50 of the sheet distinguishing device 3 of Modification (4).

FIG. 21A is a conceptual diagram for calculating distance to an approximated straight line of Modification (5); and FIG. 21B is a graph illustrating a relationship between distance to the approximated straight line and grammage.

FIG. 22 is a table illustrating an example of a data structure of a correction table 211 for correcting thresholds of Modification (6).

FIG. 23 is a graph illustrating a relationship between slope and grammage for Modification (6). This graph indicates corrected thresholds.

FIG. 24 is a flowchart illustrating operations of the main controller 50 of the sheet distinguishing device 3 of Modification (6).

FIG. 25 is a schematic cross-section illustrating configuration of an image forming device 100 of Embodiment 2.

### EMBODIMENTS

### 1. Findings Underlying the Present Disclosure

The inventor of the present disclosure irradiated various commercially available sheets with light in a wavelength band between 400 nm and 2000 nm, and measured transmittance (%) of light transmitted through each sheet.

Here, light transmittance is defined as follows.

Light transmittance=(intensity of light transmitted through sheet)/(intensity of light incident on sheet)×100 (Equation 1)

Sheets used for measurement were four types of coated paper coated with a coating material and four types of uncoated paper not coated with a coating material. The coated paper includes matte paper with a matte coating and glossy paper with a gloss coating. Further, the uncoated paper includes plain paper and color paper.

### (Wavelength Distribution of Transmittance)

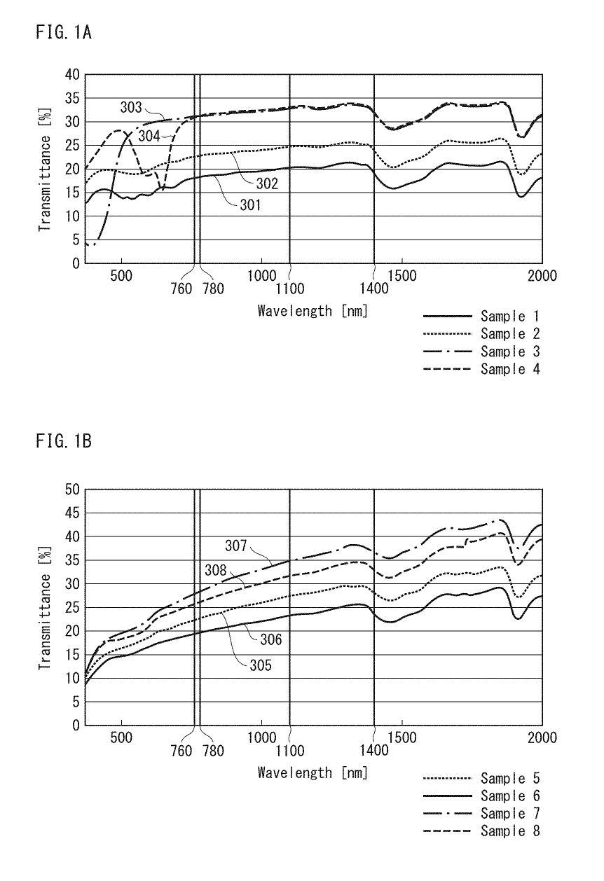

In FIG. 1A, four types of uncoated paper (referred to as samples 1-4) are irradiated with light of a wavelength band between 400 nm and 2000 nm, and a wavelength distribution of transmittance of light transmitted through each type of uncoated paper is indicated by transmittance curves 301, 302, 303, 304. The transmittance curves 301, 302, 303, 304 correspond to the samples 1-4 of uncoated paper, respectively. Here, the samples 1 and 2 are plain paper and the samples 3 and 4 are color paper. In this graph, the horizontal axis indicates light wavelength (nm) and the vertical axis indicates light transmittance (%).

As indicated in FIG. 1A, for any uncoated paper at wavelengths less than approximately 760 nm, light transmittance irregularly increases and decreases according to wavelength. Further, for any uncoated paper in a wavelength band of near infrared light between 760 nm and 1400 nm, light transmittance can be read as substantially monotonically increasing as wavelength increases. In particular, in a wavelength band between 780 nm and 1100 nm, a stable monotonic increase can be seen. Further, for any uncoated paper at wavelengths greater than approximately 1400 nm, light transmittance irregularly increases and decreases according to wavelength.

Further, in a wavelength band from 760 nm to 1400 nm, slopes of the transmittance curves 301, 302, 303, 304 can be read as almost identical to each other. In particular, in the wavelength band between 780 nm and 1100 nm, the trend is remarkable.

In FIG. 1B, four types of coated paper (referred to as samples 5-8) are irradiated with light of a wavelength band between 400 nm and 2000 nm, and a wavelength distribution of transmittance of light transmitted through each type of coated paper is indicated by transmittance curves 305, 306, 307, 308. The transmittance curves 305, 306, 307, 308 correspond to the samples 5-8 of coated paper, respectively. Here, the samples 5 and 6 are matte paper and the samples 7 and 8 are glossy paper. In this graph, the horizontal axis indicates light wavelength (nm) and the vertical axis indicates light transmittance (%).

As indicated in FIG. 1B, for any coated paper at wavelengths less than approximately 760 nm, light transmittance can be read as substantially monotonically increasing as wavelength increases. Further, for any coated paper in a wavelength band between 760 nm and 1400 nm, light transmittance can be read as substantially monotonically increasing as wavelength increases. In particular, in a wavelength band between 780 nm and 1100 nm, a stable monotonic increase can be seen. Further, for any coated paper at wavelengths greater than approximately 1400 nm, light transmittance irregularly increases and decreases according to wavelength.

Further, in a wavelength band from 760 nm to 1400 nm, slopes of the transmittance curves 305, 306, 307, 308 can be read as different from each other. In particular, in a wavelength band between 780 nm and 1100 nm, the slopes of the transmittance curves 305, 306, 307, 308 increase in the order 306, 305, 308, 307.

Further, in the wavelength band between 780 nm and 1100 nm, the slopes of the transmittance curves 305, 306, 307, 308 illustrated in FIG. 1B can be read as greater than the slopes of the transmittance curves 301, 302, 303, 304 illustrated in FIG. 1A.

### (Transmittance Ratio)

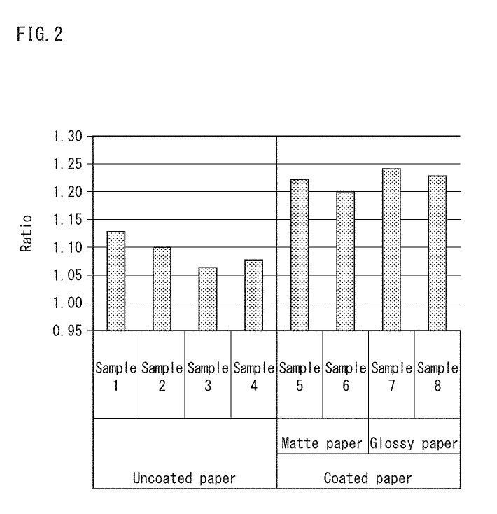

FIG. 2 illustrates ratios of a second transmittance of light at wavelength 1100 nm to a first transmittance of light at wavelength 780 nm, for uncoated paper (the samples 1-4) and coated paper (the samples 5-8). In FIG. 2, the horizontal axis indicates sheet sample names, and the vertical axis indicates ratio. Here, ratio indicates a degree of deviation of the transmittance curve (distribution curve) from the horizontal axis.

Here, the ratio is defined as follows.

Ratio=(second transmittance of light at wavelength 1100 nm)/(first transmittance of light at wavelength 780 nm) (Equation 2)

The ratio is a characteristic value with respect to a wavelength distribution of light intensity, and indicates a degree of deviation from the horizontal axis of a distribution curve representing a wavelength distribution

According to FIG. 2, the ratios for uncoated paper are less than 1.15, and the ratios for coated paper are at least 1.15.

Accordingly, by using the ratio of the second transmittance of light at wavelength 1100 nm to the first transmittance of light at wavelength 780 nm, if the ratio is less than a threshold of 1.15, for example, it can be determined that the sheet is uncoated paper, and if the ratio is greater than or equal to the threshold, it can be determined that the sheet is coated paper.

Thus, by comparing the ratio of the second transmittance of light at wavelength 1100 nm to the first transmittance of light at wavelength 780 nm to a threshold value, it is possible to determine sheet type (determine whether a sheet is coated paper or uncoated paper).

### (Review)

Accordingly, by using the ratio of the second transmittance of light at wavelength 1100 nm to the first transmittance of light at wavelength 780 nm (=(second transmittance)/(first transmittance)), if the ratio is less than a threshold, it can be determined that the sheet is uncoated paper, and if the ratio is greater than or equal to the threshold, it can be determined that the sheet is coated paper. In this way, sheet type can be determined.

Further, by using a slope of a transmittance curve in a wavelength band from 780 nm to 1100 nm, it can be determined that a sheet is uncoated if the slope is below a threshold, and it can be determined that the sheet is coated if the slope is equal to or above the threshold. In this way, sheet type can be determined.

### 2. Embodiment 1

Embodiment 1 is described below, with reference to the drawings.

### 2.1. Configuration of Image Forming Device 1

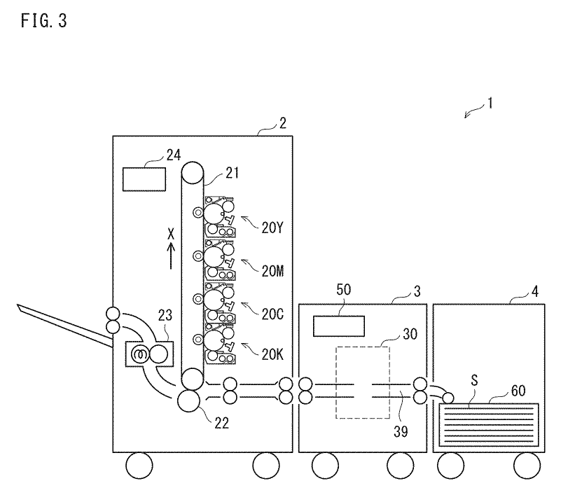

FIG. 3 is a diagram illustrating a schematic configuration of image forming device 1.

The image forming device 1 in FIG. 3 is configured such that a paper feed device 4, a sheet distinguishing device 3, and a printer 2 are connected in this order from an upstream side to a downstream side in a sheet conveyance direction.

A sheet is fed from a paper cassette 60 of the paper feed device 4 to the sheet distinguishing device 3, in accordance with an image forming operation by the printer 2. When a sheet fed from the paper cassette 60 passes through a feed path 39 in the sheet distinguishing device 3, the type of the sheet is determined. The sheet distinguishing device 3 notifies the printer 2 of the sheet type. The sheet that has passed through the feed path 39 of the sheet distinguishing device 3 is fed to the printer 2.

The printer 2 is a tandem type color printer. The printer 2 includes imaging units 20Y, 20M, 20C, 20K arranged in a vertical direction and an intermediate transfer belt 21 disposed in the vertical direction alongside the imaging units 20Y, 20M, 20C, 20K. The printer 2 performs image forming according to an image forming condition set according to the sheet type that the printer 2 is notified of by the sheet distinguishing device 3.

According to control of the main controller 24 of the printer 2, in each of the imaging units 20Y, 20M, 20C, 20K, a photosensitive drum is uniformly charged by a charging roller, exposed to light by an LED array, and an electrostatic latent image is formed on a surface of the photosensitive drum. The electrostatic latent images are each developed by a developer of a corresponding color, forming Y, M, C, K single color toner images on surfaces of the corresponding photosensitive drums, then the toner images are sequentially transferred onto a surface of the intermediate transfer belt 21 by electrostatic action of primary transfer rollers disposed on a reverse side of the intermediate transfer belt 21.

Meanwhile, the sheet is fed from the paper feed device 4 and the sheet distinguishing device 3 in coordination with the imaging operations by the imaging units 20Y, 20M, 20C, 20K. The fed sheet is conveyed on a conveyance path to a position where a secondary transfer roller 22 and a backup roller sandwich the intermediate transfer belt 21 (secondary transfer position), and at the secondary transfer position the Y, M, C, K color toner image on the intermediate transfer belt 21 is transferred to the sheet according to electrostatic action of the secondary transfer roller 22 (secondary transfer). The sheet on which the Y, M, C, K color toner image is transferred is conveyed to a fixing unit 23.

As the toner image on the surface of the sheet passes through a fixing nip formed between a heating roller of the fixing unit 23 and a pressure roller pressed against the heating roller, the toner image is fixed to the surface of the sheet by heat and pressure. After the sheet passes through the fixing unit 23, the sheet is discharged to a discharge tray. 2.2. Primary controller 24

A configuration of the main controller 24 is described.

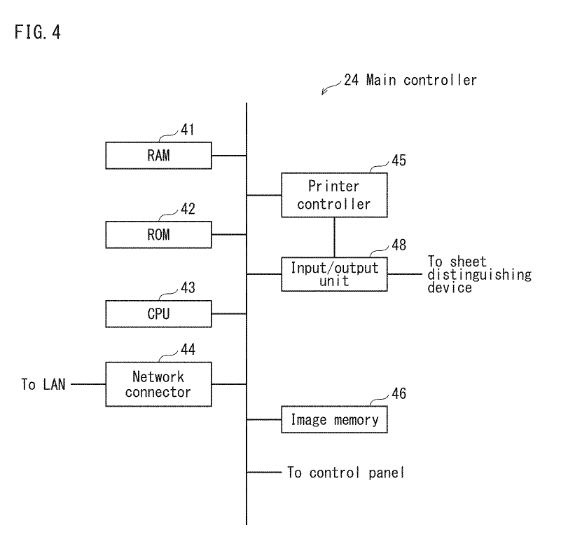

FIG. 4 is a block diagram illustrating the configuration of the main controller 24.

As illustrated in FIG. 4, the main controller 24 includes a RAM 41, a ROM 42, a CPU 43, a network connector 44, a printer controller 45, an image memory 46, an input/output unit 48, and the like.

When accepting a print job from an external terminal device such as a personal computer (PC) via the network connector 44, the main controller 24 instructs the printer controller 45 to perform print processing.

The printer controller 45 uniformly controls sheet feeding operations from the paper feed device 4, imaging operations of the imaging units 20Y, 20M, 20C, 20K, and the like, and causes image forming operations to be executed. The printer controller 45 includes a CPU and ROM, and executes controls based on a control program stored in the ROM. Further, the printer controller 45 receives from the sheet distinguishing device 3, via the input/output unit 48, notification of the sheet type of a sheet that passes through the sheet distinguishing device 3. Upon receiving notification of the sheet type, the printer controller 45 sets an image forming condition according to the received sheet type, and controls imaging operations of the imaging units 20Y, 20M, 20C, 20K and the like according to the image forming condition set, and causes execution of image forming operations.

The RAM 41 temporarily stores various control executables and the like, and also provides a work area during program execution by the CPU 43.

The ROM 42 stores control programs and the like, for causing execution of various jobs such as print jobs.

The network connector 44 receives print jobs from an external terminal device via a network such as a local area network (LAN).

The CPU 43 controls the network connector 44, the printer controller 45, and the like, operating according to control programs stored in the ROM 42. For example, the CPU 43, operating according to control programs and upon receiving a print job via the network connector 44, instructs the printer controller 45 to cause execution of image forming operations based on data of the print job.

The image memory 46 temporarily stores image data of print jobs and the like.

### 2.3 Sheet Distinguishing Device 3

The sheet distinguishing device 3 determines sheet type as described below.

As illustrated in FIG. 3, the sheet distinguishing device 3 includes the main controller 50 and a sensor unit 30 disposed so as to sandwich a sheet S that passes through the feed path 39 from the paper cassette 60.

### (1) Sensor Unit 30

As illustrated in FIG. 5, the sensor unit 30 includes a light emitting element 31 (light emitter) that emits light at wavelength 780 nm and a light emitting element 32 (light emitter) that emits light at wavelength 1100 nm that irradiates a surface of the sheet S (the surface on which a toner image is formed by the printer 2) passing through the feed path 39 from a direction substantially perpendicular to the surface of the sheet S, and a light receiving element 33 (light receiver) that receives transmitted light from the light emitting element 31 and the light emitting element 32 transmitted through the sheet S. The light emitting element 31 and the light emitting element 32 emit light at the same intensity.

The light emitting elements may be light emitting diodes, for example, and the light receiving element may be a phototransistor, a photodiode, or the like.

Further, the sensor unit 30 includes a drive circuit that is not illustrated. The drive circuit receives instruction regarding timing and light emission period for each light emitting element from the main controller 50, in accordance with a timing at which the sheet S passes through, and controls the light emitting element 31 and the light emitting element 32 so that the light emitting element 31 and the light emitting element 32 emit light at the designated timing for the designated light emission period.

Under the control of the drive circuit, the light emitting element 31 and the light emitting element 32 emit light at the timing designated and for the light emission period designated by the main controller 50.

Further, when the light receiving element 33 receives transmitted light transmitted through the sheet S due to light emission from the light emitting element 31 and/or the light emitting element 32, the drive circuit receives a signal indicating intensity of the transmitted light from the light receiving element 33. The drive circuit amplifies and converts a received signal into a digital signal, and outputs the digital signal to the main controller 50.

### (2) Primary Controller 50

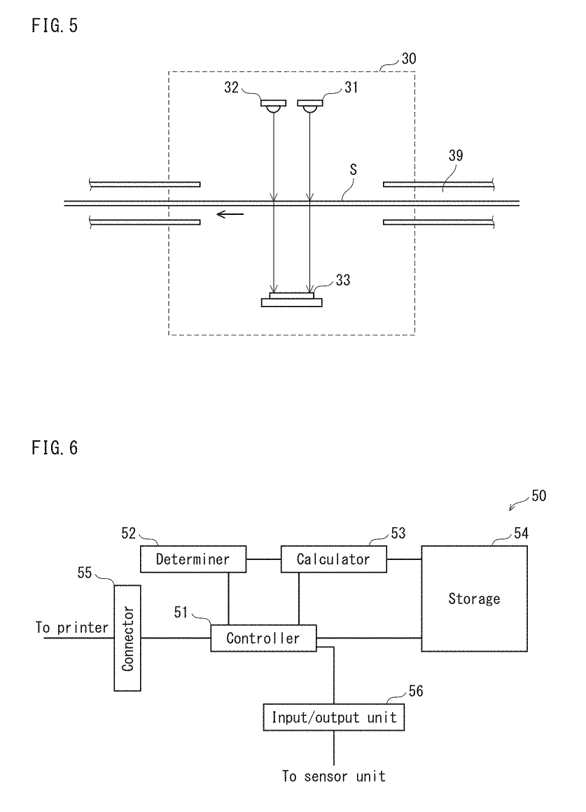

In FIG. 6, the main controller 50 includes a controller 51, a determiner 52, a calculator 53, a storage 54, a connector 55, and an input/output unit 56. More specifically, the main controller 50 is a computer system including RAM, ROM, CPU, etc.

The controller 51, the determiner 52, and the calculator 53 achieve their respective functions through CPU operations according to control programs stored in ROM.

### (Storage 54)

The storage 54 includes, for example, non-volatile semiconductor memory.

The storage 54 stores a first threshold. The first threshold is used for comparing the ratio of the second transmittance of light at wavelength 1100 nm to the first transmittance of light at wavelength 780 nm.

If the ratio is less than the first threshold (outside a defined range), the sheet is determined to be uncoated paper, and if the ratio is equal to or greater than the first threshold (in a defined range), the sheet is determined to be coated paper.

As one example, the first threshold is 1.15.

### (Controller 51)

The controller 51 causes the light emitting elements 31, 32 to emit light at the designated timing for the designated light emission period, via the input/output unit 56 and the drive circuit of the sensor unit 30. The controller 51 designates timing such that the light emitting element 31 is first caused to emit light, and after the light emission period has elapsed, the light emitting element 32 is caused to emit light. An example of a designated light emission period with respect to the light emitting elements 31, 32, is 10 ms.

The controller 51 receives from the light receiving element 33 the first signal indicating intensity of transmitted light, and subsequently receives a second signal indicating intensity of transmitted light, via the drive circuit of the sensor unit 30. The first signal is a signal indicating intensity of transmitted light from light emitted by the light emitting element 31, and the second signal is a signal indicating intensity of transmitted light from light emitted by the light emitting element 32. The controller 51 outputs the received first signal and second signal to the calculator 53.

According to the determiner 52, if the ratio is determined to be smaller than the first threshold, the controller 51 sets the sheet type to “A” (uncoated paper). According to the determiner 52, if the ratio is determined to be equal to or greater than the first threshold, the controller 51 sets the sheet type to “B” (coated paper).

The controller 51 notifies the printer controller 45 of the sheet type set, via the connector 55 and the input/output unit 48.

### (Calculator 53)

The calculator 53 receives from the controller 51 the first signal indicating intensity of received light, and calculates the first transmittance by using the first signal.

Further, the calculator 53 receives from the controller 51 the second signal indicating intensity of received light, and calculates the second transmittance by using the second signal.

The calculator calculates the ratio according to the following equation.

Ratio=(second transmittance)/(first transmittance) (Equation 3)

The calculator 53 outputs a calculated ratio to the determiner 52.

### (Determiner 52)

The determiner 52 receives the ratio calculated by the calculator 53 and compares the calculated ratio to the first threshold. Thus, the determiner 52 determines whether a sheet belongs to a first type (coated paper) or a second type (uncoated paper). The determiner 52 outputs a result of comparison to the controller 51.

### (Connector 55)

The connector 55 relays transmission and reception of control information such as sheet type between the controller 51 and the input/output unit 48 of the printer 2.

### (Input/Output Unit 56)

The input/output unit 56 relays transmission and reception of control information and signals such as light emission timing and light emission period between the controller 51 and the drive circuit of the sensor unit 30.

### 2.4. Operations of Sheet Distinguishing Device 3

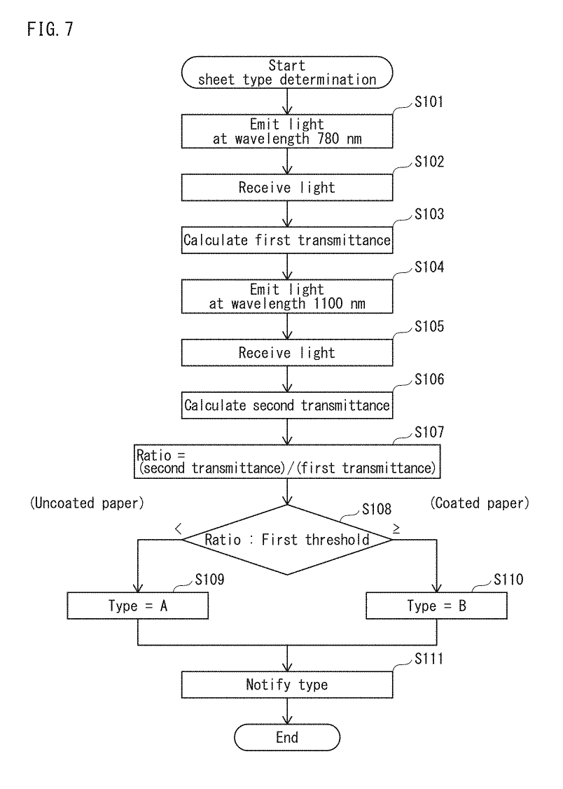

Operations of the sheet distinguishing device 3 are described below with reference to the flowchart illustrated in FIG. 7.

According to control of the controller 51, the light emitting element 31 emits light at wavelength 780 nm at a timing designated by the controller 51 for an emission period designated by the controller 51 (step S101). Next, the light receiving element 33 receives light emitted from the light emitting element 31 and transmitted through the sheet S, and outputs the first signal indicating intensity of received light to the controller 51, via the input/output unit 56 (step S102).

The calculator 53 receives from the controller 51 the first signal indicating intensity of received light, and calculates the first transmittance by using the first signal (step S103).

Next, according to control of the controller 51, the light emitting element 32 emits light at wavelength 1100 nm at a timing designated by the controller 51 for an emission period designated by the controller 51 (step S104). Next, the light receiving element 33 receives light emitted from the light emitting element 32 and transmitted through the sheet S, and outputs the second signal indicating intensity of received light to the controller 51, via the input/output unit 56 (step S105).

The calculator 53 receives from the controller 51 the second signal indicating intensity of received light, and calculates the second transmittance by using the second signal (step S106).

Next, the calculator 53 calculates the ratio (=(second transmittance)/(first transmittance)) and outputs the calculated ratio to the determiner 52 (step S107).

Next, the determiner 52 receives the calculated ratio from the calculator 53, and compares the ratio to the first threshold (step S108). If the ratio is less than the first threshold (“<” at step S108), the controller 51 sets the sheet type to “A” (uncoated paper) (step S109). If the ratio is equal to or greater than the first threshold (“≥” at step S108), the controller 51 sets the sheet type to “B” (coated paper) (step S110).

Next, the controller 51 notifies the printer controller 45 of the sheet type set, via the connector 55 and the input/output unit 48 (step S111).

### 2.5. Review

As described above, the light emitting element 31 emits light at wavelength 780 nm, and the light receiving element 33 outputs a first signal indicating intensity of light transmitted through the sheet S. The calculator 53 calculates the first transmittance according to the first signal. Further, the light emitting element 32 emits light at wavelength 1100 nm, and the light receiving element 33 outputs a second signal indicating intensity of light transmitted through the sheet S. The calculator 53 calculates the second transmittance according to the second signal.

The calculator 53 calculates the ratio (=(second transmittance)/(first transmittance)), and the determiner 52 compares the calculated ratio to the first threshold. If the ratio is smaller than the first threshold, the controller 51 sets the sheet type to “A” (uncoated paper). If the ratio is equal to or greater than the first threshold, the controller 51 sets the sheet type to “B” (coated paper).

Next, the controller 51 notifies the printer controller 45 of the sheet type set, via the connector 55 and the input/output unit 48. The printer controller 45 sets an image forming condition according to the sheet type notified, and executes image forming.

Thus, it is possible to determine sheet type, and to perform image forming according to an image forming condition set according to the sheet type.

### 3. Modification (1)

An image forming device as Modification (1) of Embodiment 1 has substantially the same structure as the image forming device of Embodiment 1, with at least one exception. Here, the image forming device of Modification (1) is described focusing on differences from Embodiment 1.

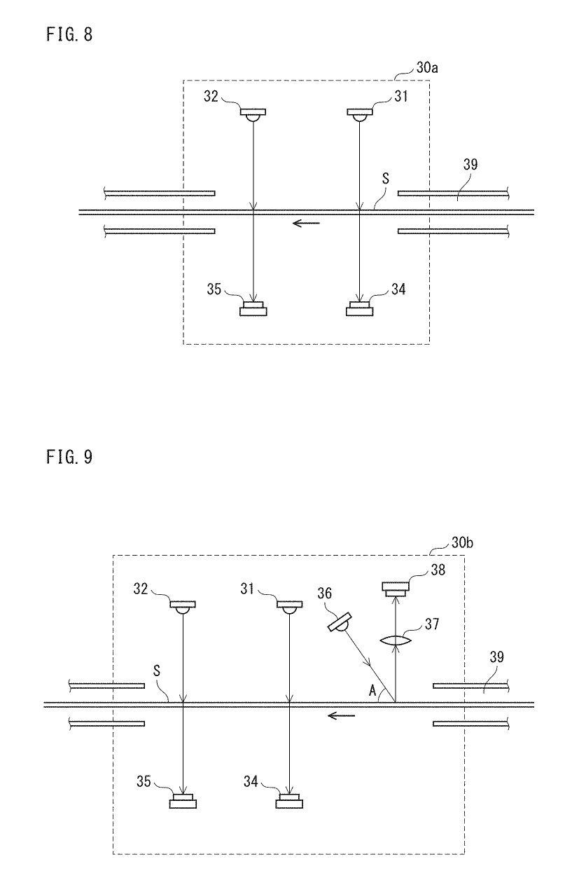

The image forming device of Modification (1) includes a sensor unit 30a, as illustrated in FIG. 8, instead of the sensor unit 30 of the sheet distinguishing device 3.

Like the sensor unit 30, the sensor unit 30a includes the light emitting element 31 (light emitter) and the light emitting element 32 (light emitter).

Further, instead of the light receiving element 33 of the sensor unit 30, the sensor unit 30a includes a light receiving element 34 (light receiver) and a light receiving element 35 (light receiver). The light receiving element 34 receives light emitted by the light emitting element 31 and transmitted through a sheet, and outputs the first signal indicating intensity of light to the controller 51, via a drive circuit. The light receiving element 35 receives light emitted by the light emitting element 32 and transmitted through a sheet, and outputs the second signal indicating intensity of light to the controller 51, via a drive circuit.

Here, the controller 51 may cause light emission by the light emitting element 31 and the light emitting element 32 at different timings, and may cause light emission at the same timings.

According to this configuration, the light emitting element 31 and the light emitting element 32 may be made to emit light at different timings or the same timings, and therefore, in comparison to Embodiment 1, there is an advantage in that control by the controller 51 is made easier.

### 4. Modification (2)

An image forming device as Modification (2) of Embodiment 1 has substantially the same structure as the image forming device of Embodiment 1, with at least one exception. Here, the image forming device of Modification (2) is described focusing on differences from Embodiment 1.

The image forming device of Modification (2) includes a sensor unit 30b, as illustrated in FIG. 9, instead of the sensor unit 30 of the sheet distinguishing device 3. Further, the image forming device includes the main controller 50 that has the same structure as the main controller 50 of the sheet distinguishing device 3 of Embodiment 1 (FIG. 6).

### 4.1. Sensor Unit 30b

Like the sensor unit 30, the sensor unit 30b includes the light emitting element 31 (light emitter) and the light emitting element 32 (light emitter).

Further, instead of the light receiving element 33 of the sensor unit 30, the sensor unit 30b includes the light receiving element 34 (light receiver) and the light receiving element 35 (light receiver). The light receiving element 34 receives light emitted by the light emitting element 31 and transmitted through a sheet, and outputs the first signal indicating intensity of light to the controller 51, via a drive circuit. The light receiving element 35 receives light emitted by the light emitting element 32 and transmitted through a sheet, and outputs the second signal indicating intensity of light to the controller 51, via a drive circuit.

Further, the sensor unit 30b includes a light emitting element 36, an optical element 37, and a light receiving element 38 as a gloss level detector.

The light emitting element 36 emits light at wavelength 1100 nm towards the surface of the sheet S passing through the feed path 39, forming an angle A between the main direction of emission and the surface of the sheet S. The angle A is 75° in this example.

The optical element 37 is disposed in a light path of light emitted from the light emitting element 36 and reflected in a direction perpendicular to the plane of the surface of the sheet S. The optical element 37 focuses light reflected at the surface of the sheet S, and causes the focused light to irradiate the light receiving element 38.

The light receiving element 38 receives light reflected at the surface of the sheet S and focused by the optical element 37, and outputs a third signal indicating intensity of light to the controller 51, via a drive circuit.

### 4.2. Primary Controller 50

Regarding the controller 51, the determiner 52, the calculator 53, and the storage 54 of the main controller 50, the following description focuses on differences from Embodiment 1 (see FIG. 6).

### (Storage 54)

The storage 54 further stores a second threshold.

The second threshold is used for comparison with a specular reflectance, described later.

### (Controller 51)

The controller 51 causes the light emitting element 36 to emit light at a designated timing for a designated light emission period, via the input/output unit 56 and the drive circuit of the sensor unit 30b. An example of a designated light emission period with respect to the light emitting element 36 is 10 ms.

The controller 51 may first cause the light emitting element 36 to emit light, and after the light emission period of the light emitting element 36 has elapsed, cause the light emitting elements 31, 32 to emit light at different timings from each other or at the same timings as each other. Further, the controller 51 may cause the light emitting elements 36, 31, 32 to emit light at the same timings as each other.

The controller 51 receives from the light receiving element 38 the third signal indicating intensity of specular reflection, via the drive circuit and the input/output unit 56. The controller 51 outputs the received third signal to the calculator 53.

The controller 51 sets sheet type to “1” (plain paper) if the ratio is less than the first threshold and the specular reflectance is less than the second threshold.

The controller 51 sets sheet type to “2” (high-quality paper) if the ratio is less than the first threshold and the specular reflectance is equal to or greater than the second threshold.

The controller 51 sets the sheet type to “3” (matte paper) if the ratio is equal to or greater than the first threshold and the specular reflectance is less than the second threshold.

The controller 51 sets the sheet type to “4” (glossy paper) if the ratio is equal to or greater than the first threshold and the specular reflectance is equal to or greater than the second threshold.

The controller 51 notifies the printer controller 45 of the sheet type set, via the connector 55 and the input/output unit 48.

### (Calculator 53)

The calculator 53 receives from the controller 51 the third signal indicating intensity of received light, and calculates specular reflectance by using the third signal.

Specular reflectance=(intensity of reflected light, i.e., third signal)/(intensity of light incident on sheet)×100 (Equation 4)

### (Determiner 52)

The determiner 52 receives the specular reflectance calculated by the calculator 53 and compares the specular reflectance to the second threshold. The determiner 52 outputs a result of comparison to the controller 51.

### 4.3. Operations of Sheet Distinguishing Device 3 of Modification (2)

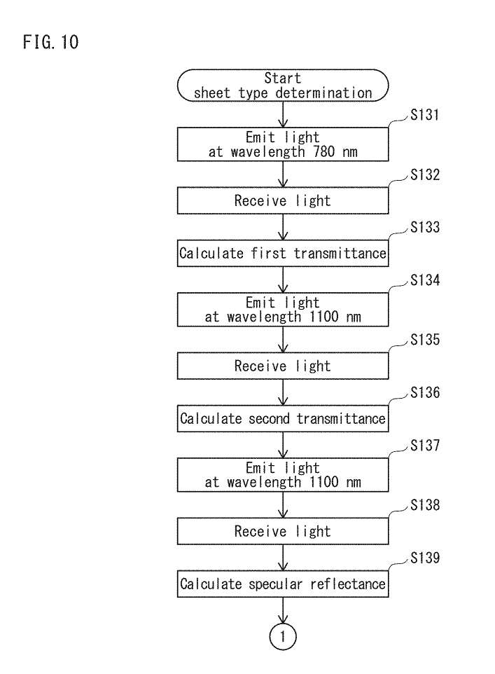

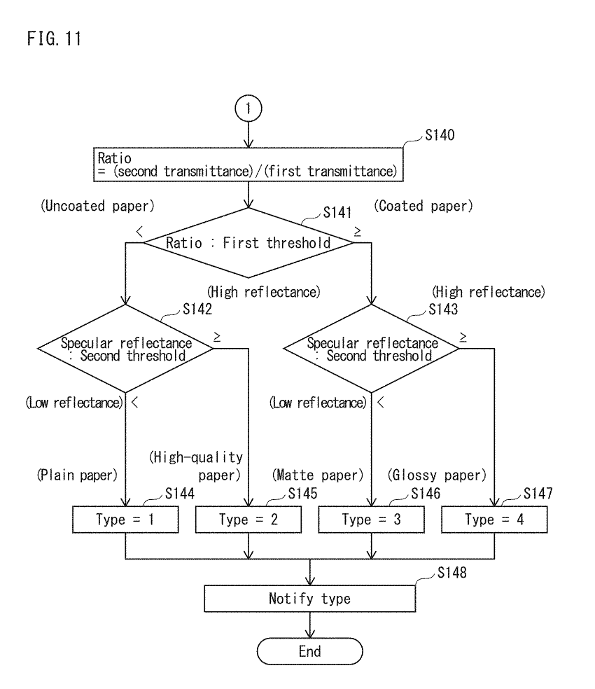

Operations of the sheet distinguishing device 3 of Modification (2) are described below with reference to the flowcharts illustrated in FIG. 10 and FIG. 11.

According to control of the controller 51, the light emitting element 31 emits light at wavelength 780 nm at a timing designated by the controller 51 for an emission period designated by the controller 51 (step S131). Next, the light receiving element 34 receives light emitted from the light emitting element 31 and transmitted through the sheet S, and the drive circuit outputs the first signal indicating intensity of received light to the controller 51, via the input/output unit 56 (step S132).

The calculator 53 receives from the controller 51 the first signal indicating intensity of received light, and calculates the first transmittance by using the first signal (step S133).

Next, according to control of the controller 51, the light emitting element 32 emits light at wavelength 1100 nm at a timing designated by the controller 51 for an emission period designated by the controller 51 (step S134). Next, the light receiving element 35 receives light emitted from the light emitting element 32 and transmitted through the sheet S, and the drive circuit outputs the second signal indicating intensity of received light to the controller 51, via the input/output unit 56 (step S135).

The calculator 53 receives from the controller 51 the second signal indicating intensity of received light, and calculates the second transmittance by using the second signal (step S136).

Next, according to control of the controller 51, the light emitting element 36 emits light at wavelength 1100 nm at a timing designated by the controller 51 for an emission period designated by the controller 51 (step S137). Next, the light receiving element 38 receives light emitted from the light emitting element 36 and reflected at the sheet S, and the drive circuit outputs the third signal indicating intensity of received light to the controller 51, via the input/output unit 56 (step S138).

The calculator 53 receives from the controller 51 the third signal indicating intensity of received light, and calculates the specular reflectance by using the third signal (step S139).

Next, the calculator 53 calculates the ratio (=(second transmittance)/(first transmittance)) and outputs the calculated ratio to the determiner 52 (step S140).

Next, the determiner 52 receives the calculated ratio from the calculator 53, and compares the ratio to the first threshold (step S141). If the ratio is less than the first threshold (“<” at step S141), the determiner 52 receives the calculated specular reflectance from the calculator 53 and compares the specular reflectance to the second threshold (step S142). If the specular reflectance is less than the second threshold (“<” at step S142), the controller 51 sets the sheet type to “1” (plain paper) (step S144). If the specular reflectance is equal to or greater than the second threshold (“≥” at step S142), the controller 51 sets the sheet type to “2” (high-quality paper) (step S145).

If the ratio is equal to or greater than the first threshold (“≥” at step S141), the determiner 52 receives the calculated specular reflectance from the calculator 53 and compares the specular reflectance to the second threshold (step S143). If the specular reflectance is less than the second threshold (“<” at step S143), the controller 51 sets the sheet type to “3” (matte paper) (step S146). If the specular reflectance is equal to or greater than the second threshold (“≥” at step S143), the controller 51 sets the sheet type to “4” (glossy paper) (step S147).

Next, the controller 51 notifies the printer controller 45 of the sheet type set, via the connector 55 and the input/output unit 48 (step S148).

### 4.4. Review

As described above, by comparing the specular reflectance to the second threshold in addition to comparing the ratio (=(second transmittance)/(first transmittance)) to the first threshold, reflective and non-reflective sheets can be distinguished.

As a result, plain paper, high-quality paper, matte paper (coated paper), and glossy paper (coated paper) can be distinguished.

The light emitting element 36 is described as emitting light at wavelength 1100 nm. However, the wavelength of 1100 nm is merely an example, and other wavelengths may be used.

### 5. Modification (3)

An image forming device as Modification (3) of Embodiment 1 has substantially the same structure as the image forming device of Embodiment 1, with at least one exception. Here, the image forming device of Modification (3) is described focusing on differences from Embodiment 1.

According to Embodiment 1 and Modifications (1) and (2), the ratio of the second transmittance to the first transmittance ((second transmittance)/(first transmittance)) is calculated, and coated paper and uncoated paper are distinguished by comparing the calculated ratio to the first threshold.

However, no limitation to this method is intended. Instead of distinguishing between coated paper and uncoated paper by comparing the calculated ratio to the first threshold, the following method may be used.

As described under the heading “1. Findings underlying the present disclosure”, and as illustrated in FIG. 1A and FIG. 1B, the slope of the transmittance curve for uncoated paper in the wavelength band between 780 nm and 1100 nm is substantially constant for any uncoated paper. On the other hand, for any coated paper, the slope of the transmittance curve in the wavelength band between 780 nm and 1100 nm is greater than the slope of the transmittance curve for any uncoated paper. Modification (3) makes use of this property.

The image forming device of Modification (3) includes the main controller 50 that has the same structure as the main controller 50 of the sheet distinguishing device 3 of Embodiment 1 (FIG. 6).

The calculator 53, calculates slope of the transmittance curve in the wavelength band from 780 nm to 1100 nm according to the following equation:

Slope=((second transmittance)−(first transmittance))/((second wavelength)−(first wavelength)) (Equation 5)

The slope indicates a degree of deviation of the transmittance curve (distribution curve) from the horizontal axis. The first wavelength is 780 nm, and the second wavelength is 1100 nm. Further, the first transmittance is transmittance of light at the first wavelength and the second transmittance is transmittance of light at the second wavelength.

Note that the slope of the transmittance curve for the wavelength band between 780 nm and 1100 nm is a characteristic value of a wavelength distribution of light intensity, and indicates a degree of deviation of a distribution curve of the wavelength distribution of light intensity from the horizontal axis.

Next, the determiner compares the calculated slope to the third threshold. If the calculated slope is equal to or greater than the third threshold, the determiner 52 determines that the sheet is coated paper. On the other hand, if the calculated slope is less than the third threshold, the determiner 52 determines that the sheet is uncoated paper.

Here, the third threshold is slightly greater than the slope of the transmittance curve for uncoated paper in the wavelength band from 780 nm to 1100 nm, such as one percent greater, for example.

If the slope is smaller than the third threshold, the controller 51 sets the sheet type to “A” (uncoated paper). If the slope is equal to or greater than the third threshold, the controller 51 sets the sheet type to “B” (coated paper). The controller 51 notifies the printer controller 45 of the sheet type set, via the connector 55 and the input/output unit 48.

In this way, according to Modification (3), as with Embodiment 1 and Modifications (1) and (2), coated paper and uncoated paper can be distinguished.

### 6. Modification (4)

An image forming device as a further Modification (4) of Modification (3) has substantially the same structure as the image forming device of Modification (3), with at least one exception. Here, the image forming device of Modification (4) is described focusing on differences from Modification (3).

According to Modification (3), the slope of the transmittance curve in the wavelength band from 780 nm to 1100 nm is calculated, and coated paper and uncoated paper are distinguished by comparing the calculated slope to the third threshold.

According to Modification (4), coated paper and uncoated paper are distinguished as described below.

The inventor of the present disclosure, in addition to the findings described under the heading “1. Findings underlying the present disclosure”, irradiated various sheets of known grammage with light in a wavelength band from 400 nm to 2000 nm, and measured transmittance (%) of light passing through each sheet.

### (Relationship Between Sheet Type and Grammage)

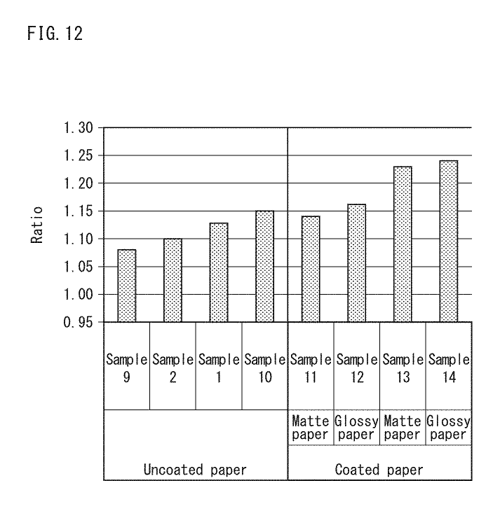

FIG. 12 illustrates the ratio of the second transmittance of light at wavelength 1100 nm to the first transmittance of light at wavelength 780 nm (=(second transmittance)/(first transmittance)) for uncoated paper (samples 1, 2, 9, 10) and coated paper (samples 11, 12, 13, 14) of known grammage. In FIG. 12, the horizontal axis indicates sheet sample names, and the vertical axis indicates ratio.

Grammages of the samples 9, 2, 1, 10, 11, 12, 13, 14 are 64 g/m², 88 g/m², 90 g/m², 210 g/m², 209 g/m², 174 g/m², 128 g/m², 79 g/m², respectively.

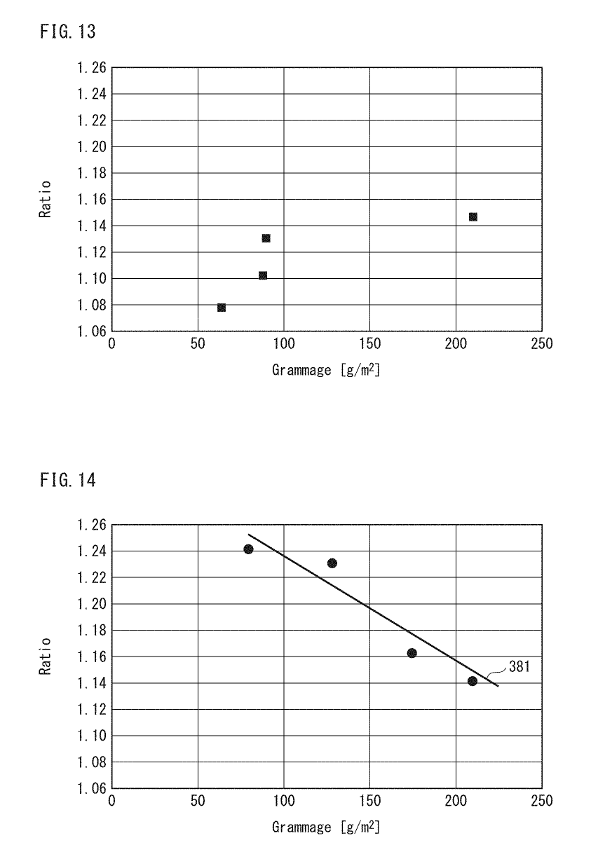

FIG. 13 is a scatter diagram in which intersections of grammage and ratio for the four types of uncoated paper indicated in FIG. 12 (samples 9, 2, 1, 10) are plotted, with position on the horizontal axis indicating grammage and position on the vertical axis indicating ratio. Further, FIG. 14 is a scatter diagram in which intersections of grammage and ratio for the four types of coated paper indicated in FIG. 12 (samples 11, 12, 13, 14) are plotted, with position on the horizontal axis indicating grammage and position on the vertical axis indicating ratio. In FIG. 13 and FIG. 14, the horizontal axis indicates grammage (g/m²), and the vertical axis indicates ratio.

According to FIG. 13, it is unclear whether or not there is any relationship between grammage and ratio regarding uncoated paper.

On the other hand, according to FIG. 14, regarding coated paper, the smaller the grammage the greater the ratio. The four plotted points are aligned near to one approximate straight line 381, and it is inferred that there is a strong negative correlation (linear correlation) between grammage and ratio for coated paper.

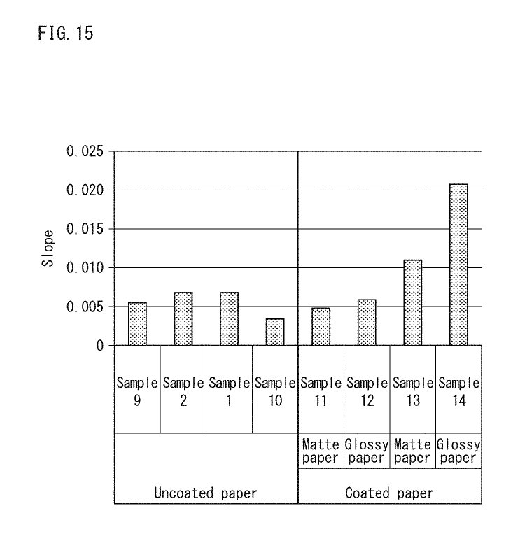

Further, FIG. 15 illustrates the slopes of transmittance curves in the wavelength band from 780 nm to 1100 nm, for the uncoated paper (samples 9, 2, 1, 10) and coated paper (samples 11, 12, 13, 14) of known grammage. In FIG. 15, the horizontal axis indicates sheet sample names, and the vertical axis indicates slope.

Here, the slopes of the transmittance curves in the wavelength band from 780 nm to 1100 nm are defined by the following equation:

Slope=((second transmittance)−(first transmittance))/((second wavelength)−(first wavelength)) (Equation 6)

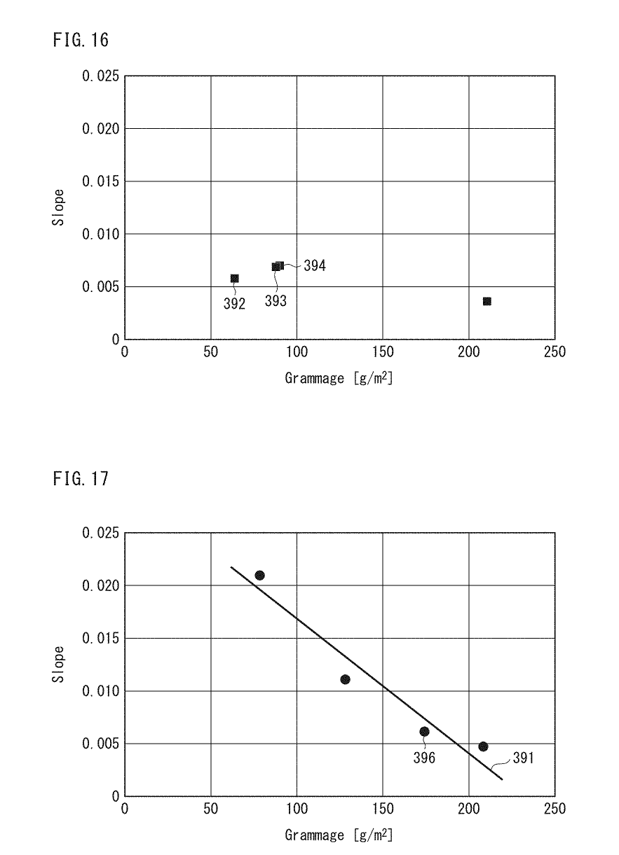

FIG. 16 is a scatter diagram in which intersections of grammage and slope for the four types of uncoated paper indicated in FIG. 15 (samples 9, 2, 1, 10) are plotted, with position on the horizontal axis indicating grammage and position on the vertical axis indicating slope of the transmittance curve in the wavelength band from 780 nm to 1100 nm. Further, FIG. 17 is a scatter diagram in which intersections of grammage and slope for the four types of coated paper indicated in FIG. 15 (samples 11, 12, 13, 14) are plotted, with position on the horizontal axis indicating grammage and position on the vertical axis indicating slope of the transmittance curve in the wavelength band from 780 nm to 1100 nm. In FIG. 16 and FIG. 17, the horizontal axis indicates grammage (g/m²), and the vertical axis indicates slope.

According to FIG. 16, it is unclear whether or not there is any relationship between grammage and slope of transmittance curve regarding uncoated paper.

On the other hand, according to FIG. 17, regarding coated paper, the smaller the grammage the greater the slope of the transmittance curve. The four plotted points are aligned near to one approximate straight line 391, and it is inferred that there is a strong negative correlation (linear correlation) between grammage and slope of transmittance curve for coated paper.

As described above, with respect to coated paper, the slope of the transmittance curve in the wavelength band between 780 nm and 1100 nm tends to decrease as sheet grammage increases, and it can be inferred that slope of the transmittance curve is dependent on grammage. Thus, by detecting sheet grammage and correcting the slope of the transmittance curve according to the detected grammage (Modification (4)), or detecting grammage and correcting the ratio according to the detected grammage (Modification (6)), it can be expected that sheet type can be determined.

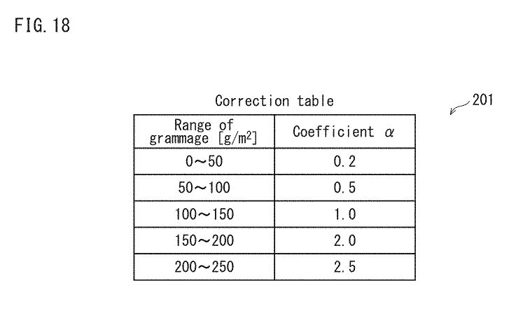

The slope of the transmittance curve calculated according to Modification (4) is corrected by using a correction table 201 in FIG. 18, and coated paper and uncoated paper are distinguished by using the corrected slope.

The image forming device of Modification (4) includes the main controller 50 that has the same structure as the main controller 50 of the sheet distinguishing device 3 of Embodiment 1 (FIG. 6).

The storage 54 stores the correction table 201 of FIG. 18.

The correction table 201, as shown in FIG. 18, includes a plurality of combinations of ranges of sheet grammage (g/m²) and a coefficient α. In the correction table 201, the greater the sheet grammage, the greater the coefficient α.

For example, when the grammage is equal to or greater than 0 g/m² and less than 50 g/m², the coefficient α is 0.2, when the grammage is equal to or greater than 50 g/m² and less than 100 g/m², the coefficient α is 0.5, when the grammage is equal to or greater than 100 g/m² and less than 150 g/m², the coefficient α is 1.0, when the grammage is equal to or greater than 150 g/m² and less than 200 g/m², the coefficient α is 2.0, and when the grammage is equal to or greater than 200 g/m² and less than 250 g/m², the coefficient α is 2.5. Note that the relationship between range of sheet grammage and the coefficient α shown in the correction table 201 is merely one example, and is not limited to this example.

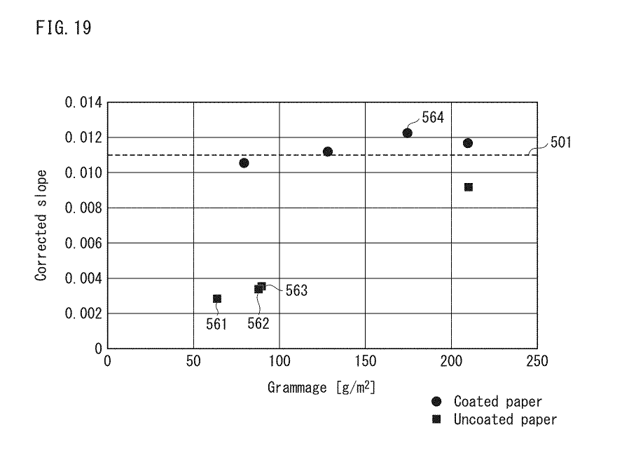

The slopes of transmittance curves for the samples 9, 2, 1, 10 (uncoated paper) and the samples 11, 12, 13, 14 (coated paper) of known grammage are corrected by using the correction table 201. FIG. 19 is a scatter diagram in which intersections of grammage and corrected slope for each sample are plotted, with position on the horizontal axis indicating grammage and position on the vertical axis indicating corrected slope. In FIG. 19, the horizontal axis indicates grammage and the vertical axis indicates corrected slope.

As indicated in FIG. 19, points plotted for the samples 11, 12, 13, 14 of coated paper are clustered around a straight line 501 parallel to the horizontal axis. In contrast, points plotted for the samples 9, 2, 1, 10 of uncoated paper are scattered and distant from the straight line 501.

Thus, by correcting the calculated slope by using the correction table 201, points plotted for coated paper are clustered around a straight line parallel to the horizontal axis, while points plotted for uncoated paper are scattered and distant from the straight line. By using these properties, coated paper and uncoated paper can be distinguished.

Here, points 392, 393, 394 indicated in FIG. 16 and point 396 indicated in FIG. 17 correspond to corrected points 561, 562, 563, 564, respectively, indicated in FIG. 19.

For example, slopes of points 392, 393, 394 indicated in FIG. 16 and point 396 indicated in FIG. 17 are close in value to each other, and therefore when using uncorrected slope values, it is difficult to determine whether the points 392, 393, 394, 396 are coated paper or uncoated paper. On the other hand, when using corrected slopes, the slopes of the points 561, 562, 563 indicated in FIG. 19 (corresponding to the points 392, 393, 394) are distant from the straight line 501, while the slope of the point 564 (corresponding to the point 396) is close to the straight line 501. Thus, for these points, distinguishing between coated paper and uncoated paper becomes possible.

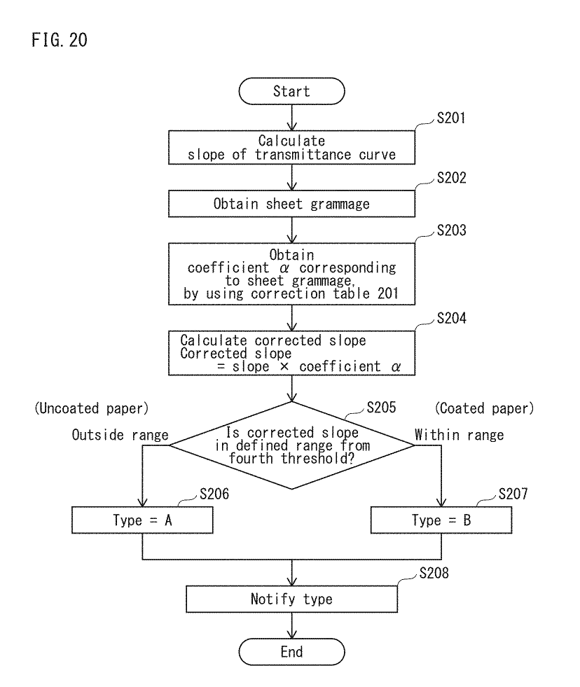

According to Modification (4), steps in determining sheet type are described with reference to the flowchart illustrated in FIG. 20.

The calculator 53 calculates slope of the transmittance curve in the wavelength band from 780 nm to 1100 nm (step S201). The method of calculating slope is the same as described for Modification (3).

The calculator 53 seeks the sheet grammage [g/m²]. It can be considered that there is a strong negative correlation between sheet grammage and transmittance, such that as grammage increases, transmittance decreases. Thus, in advance, grammages of a plurality of sheets and transmittance of each sheet at wavelength 780 nm, for example, are stored in association with each other, and using this association and the calculated transmittance at wavelength 780 nm, grammage of a sheet is predicted and calculated (step S202).

The controller 51 searches the correction table 201 for a grammage range that includes the calculated grammage, and seeks the coefficient α corresponding to the grammage range from the correction table 201 (step S203).

The calculator 53 calculates a corrected slope according to the following equation, by multiplying the slope calculated in step S201 by the coefficient α sought in step S203.

Corrected slope=(slope)×(coefficient α) (Equation 7) (step S204)

The determiner 52 determines whether or not the corrected slope is in the vicinity of a fourth threshold, that is, within a defined range from the fourth threshold (for example, within a range of +3% to −3% from the fourth threshold) (step S205).

If the corrected slope is within the defined range from the fourth threshold (“within range” at step S205), the determiner 52 determines that the sheet is coated paper. If the corrected slope is outside the defined range from the fourth threshold (“outside range” at step S205), the determiner 52 determines that the sheet is uncoated paper.

If the corrected slope is inside the defined range from the fourth threshold (“within range” at step S205), the controller 51 sets the sheet type to “B” (coated paper) (step S207). If the corrected slope is outside the defined range from the fourth threshold (“outside range” at step S205), the controller 51 sets the sheet type to “A” (uncoated paper) (step S206). The controller 51 notifies the printer controller 45 of the sheet type set, via the connector 55 and the input/output unit 48 (step S208).

Thus, according to Modification (4), the slope of a transmittance curve in the wavelength band between 780 nm and 1100 nm is calculated, the calculated slope is corrected by using the correction table 201, and whether or not the corrected slope is within a defined range from the fourth threshold is determined. Thus, coated paper and uncoated paper can be distinguished.

As described above, the light emitting element 31 emits light at wavelength 780 nm, the light receiving element 33 receives transmitted light, and the calculator 53 calculates sheet grammage by using transmittance at 780 nm. Sheet grammage is representative of sheet thickness, and therefore it can be said that the light emitting element 31, the light receiving element 33, and the calculator 53 constitute a thickness detector that detects sheet thickness.

Further, detection of sheet grammage or sheet thickness is not limited to a method using transmittance as described above. Sheet thickness may be detected by direct contact with the sheet by an actuator.

### 7. Modification (5)

An image forming device as Modification (5) of Embodiment 1 has substantially the same structure as the image forming device of Embodiment 1, with at least one exception. Here, the image forming device of Modification (5) is described focusing on differences from Embodiment 1.

The image forming device of Modification (5) includes the main controller 50 that has the same structure as the main controller 50 of the sheet distinguishing device 3 of Embodiment 1 (FIG. 6).

According to Embodiment 1, the first transmittance at wavelength 780 nm and the second transmittance at wavelength 1100 nm are calculated, the ratio ((second transmittance)/(first transmittance)) is calculated, and by comparing the ratio to the first threshold, coated paper and uncoated paper are distinguished.

According to Modification (5), coated paper and uncoated paper are distinguished as described below.

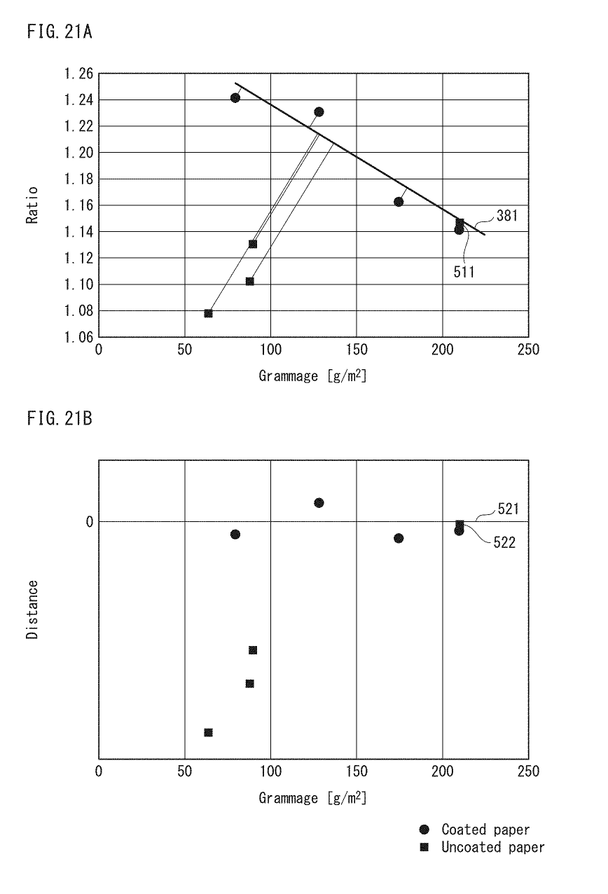

FIG. 21A is a scatter diagram in which intersections of grammage and ratio for the samples 9, 2, 1, 10 (uncoated paper) and the samples 11, 12, 13, 14 (coated paper) indicated in FIG. 12 are plotted, with position on the horizontal axis indicating grammage and position on the vertical axis indicating ratio. That is, FIG. 21A includes the points plotted in the graphs of FIG. 13 and FIG. 14 plotted on one graph. In FIG. 21A, the horizontal axis indicates grammage and the vertical axis indicates ratio.

The four plotted points for coated paper are aligned near to one approximate straight line 381, and it is inferred that there is a strong negative correlation (linear correlation) between grammage and ratio for coated paper. Among uncoated paper, only the sample 4, plotted as point 511, is positioned near to the approximate straight line 381.

Next, for each point plotted in FIG. 21A, distance to the approximate straight line 381 is calculated, and FIG. 21B illustrates a graph in which intersections between grammage and calculated distance are plotted. In FIG. 21B, the horizontal axis indicates grammage and the vertical axis indicates calculated distance.

As can be understood from FIG. 21B, the four points plotted for coated paper are arranged along the vicinity of one straight line 521 (parallel to the horizontal axis). Among uncoated paper, only the sample 4, plotted as point 522, is positioned near to the straight line 521.

In this way, for each sheet, grammage and ratio are plotted on a graph, distances of plotted points from an approximate straight line are calculated, and whether or not the calculated distance is within a defined range (for example, within a range of +3% to −3% from a threshold) is determined. Thus, although exceptions exist, whether or not a sheet is coated paper can largely be determined. Note that although plotting grammage and ratio on a graph is described in order to facilitate understanding of a method of the present disclosure, plotting grammage and ratio on a graph is not required as an actual method of calculation. It suffices to calculate distance from the approximate straight line 381 of grammage/ratio coordinates.

Here, the approximate straight line 381 may be determined in advance from grammage and ratio determined from a plurality of samples of coated paper. Parameters defining the approximate straight line, for example, a slope and a y intercept of the approximate straight line, may be stored in the storage 54. When calculating the distance, the approximate straight line stored in the storage 54 may be used.

### 8. Modification (6)

An image forming device as a further Modification (6) of Modification (3) has substantially the same structure as the image forming device of Modification (3), with at least one exception. Here, the image forming device of Modification (6) is described focusing on differences from Modification (3).

According to Modification (3), the slope of the transmittance curve in the wavelength band from 780 nm to 1100 nm is calculated, and coated paper and uncoated paper are distinguished by comparing the calculated slope to the third threshold.

According to Modification (6), coated paper and uncoated paper are distinguished as described below.

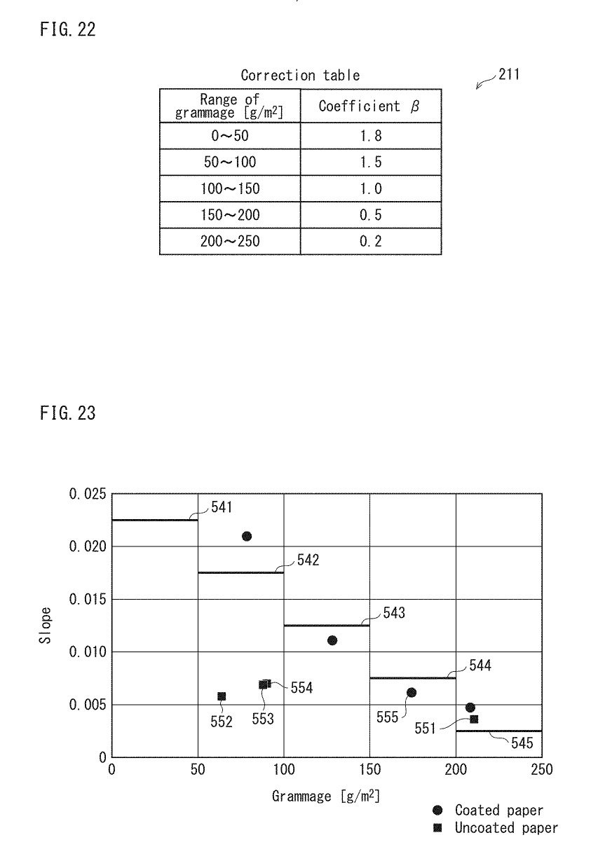

As illustrated in FIG. 17, for coated paper, as grammage of a sheet increases, the slope of the transmittance curve in the wavelength band from 780 nm to 1100 nm tends to decrease. There is a strong negative correlation between sheet grammage and slope, and this relationship may be considered to be linear. Thus, using this relationship, and using a correction table 211 illustrated in FIG. 22, a threshold is corrected, calculated slope is compared to the corrected threshold, and coated paper and uncoated paper are distinguished.

The image forming device of Modification (6) includes the main controller 50 that has the same structure as the main controller 50 of the sheet distinguishing device 3 of Embodiment 1 (FIG. 6).

The storage 54 stores the correction table 211 of FIG. 22.

The correction table 211, as shown in FIG. 22, includes a plurality of combinations of ranges of sheet grammage [g/m²] and a coefficient β. In the correction table 211, the greater the sheet grammage, the greater the coefficient β.

For example, when the grammage is equal to or greater than 0 g/m² and less than 50 g/m², the coefficient β is 1.8, when the grammage is equal to or greater than 50 g/m² and less than 100 g/m², the coefficient β is 1.5, when the grammage is equal to or greater than 100 g/m² and less than 150 g/m², the coefficient β is 1.0, when the grammage is equal to or greater than 150 g/m² and less than 200 g/m², the coefficient β is 0.5, and when the grammage is equal to or greater than 200 g/m² and less than 250 g/m², the coefficient β is 0.2. Note that the relationship between range of sheet grammage and the coefficient β shown in the correction table 211 is merely one example, and is not limited to this example.

FIG. 23 is a scatter diagram in which intersections of grammage and slope for the samples 9, 2, 1, 10 (uncoated paper) and the samples 11, 12, 13, 14 (coated paper) indicated in FIG. 15 are plotted, with position on the horizontal axis indicating grammage and position on the vertical axis indicating slope. That is, FIG. 23 includes the points plotted in the graphs of FIG. 16 and FIG. 17 plotted on one graph. In FIG. 23, the horizontal axis indicates grammage, and the vertical axis indicates slope.

Further, in FIG. 23, a threshold is multiplied by the coefficient β for each range of grammage indicated in the correction table 211, and indicated as corrected thresholds 541, 542, 543, 544, 545.

As illustrated in FIG. 23, points plotted for the samples 11, 12, 13, 14 of coated paper are in the vicinity of the corrected thresholds 542, 543, 544, 545 for each of the grammage ranges. In contrast, points 552, 553, 554 plotted for the samples 9, 2, 1 of uncoated paper are scattered and distant from the corrected thresholds 541, 542, 543, 544, 545 for each grammage range. Among point for uncoated paper, only point 551, plotted for the sample 10 of uncoated paper, is near the corrected threshold 545.

Thus, by correcting the threshold for each grammage range by using the correction table 211, points plotted for coated paper are clustered around thresholds, while points plotted for uncoated paper are scattered and distant from the thresholds. By using these properties, coated paper and uncoated paper can be distinguished.

For example, slope values at the points 552, 553, 554, 555 in FIG. 23 are similar, and therefore if an uncorrected threshold were used, distinguishing between coated paper and uncoated paper for the points 552, 553, 554, 555 would be difficult. On the other hand, when corrected thresholds are used, slope values of the points 552, 553, 554 are distant from the threshold 542, and the slope value of the point 555 is near the threshold 544, and therefore it becomes possible to distinguish between coated paper and uncoated paper for these points.

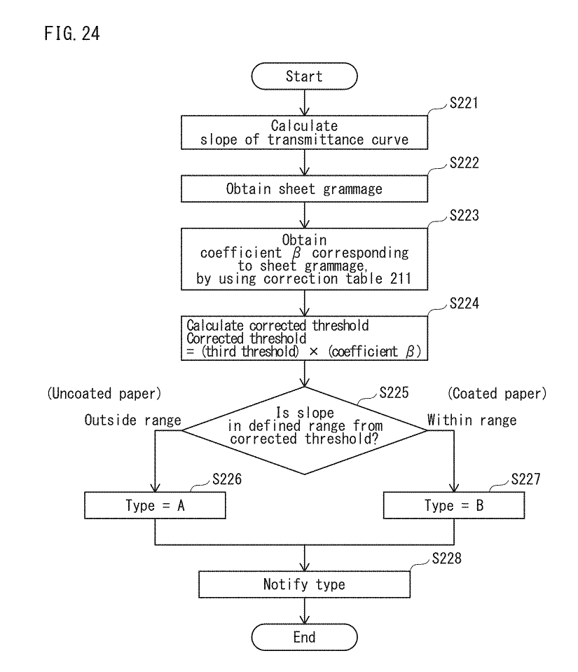

According to Modification (6), steps in determining sheet type are described with reference to the flowchart illustrated in FIG. 24.

The calculator 53 calculates slope of the transmittance curve in the wavelength band from 780 nm to 1100 nm (step S221). The method of calculating the slope is the same as described for Modification (3).

The calculator 53, as described for Modification (4), estimates sheet grammage [g/m²] by using transmittance at wavelength 780 nm (step S222).

The controller 51 searches the correction table 211 for a grammage range that includes the calculated grammage, and seeks the coefficient β corresponding to the grammage range from the correction table 211 (step S223).

The calculator 53 calculates a corrected threshold by multiplying the third threshold by the coefficient β obtained in step S223, according to the following equation:

Corrected threshold=(third threshold)×(coefficient β) (Equation 8) (step S224)

The calculator 52 determines whether or not the slope is near to the corrected threshold, i.e., in a defined range from the corrected threshold (for example, a range from +3% to −3% from the corrected threshold) (step S225).

If the slope is in the defined range from the corrected threshold (“within range” in step S225), the determiner 52 determines that the sheet is coated paper. If the slope is outside the defined range from the corrected threshold (“outside range” in step S225), the determiner 52 determines that the sheet is uncoated paper.

If the slope is in the defined range from the corrected threshold (“within range” at step S225), the controller 51 sets the sheet type to “B” (coated paper) (step S227). If the slope is outside the defined range from the corrected threshold (“outside range” at step S225), the controller 51 sets the sheet type to “A” (uncoated paper) (step S226). The controller 51 notifies the printer controller 45 of the sheet type set, via the connector 55 and the input/output unit 48 (step S228).

Thus, according to Modification (6), the threshold is corrected for each range of grammage by using the correction table to calculate the corrected threshold, and whether or not the slope is within a defined range from the corrected threshold is determined. Thus, coated paper and uncoated paper can be distinguished.

### 9. Embodiment 2

Embodiment 2 is described below, with reference to the drawings.

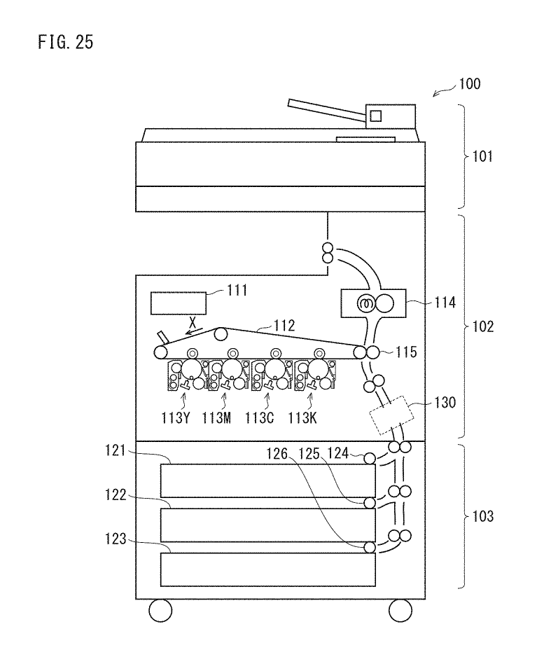

FIG. 25 is a diagram illustrating a schematic configuration of image forming device 100 as Embodiment 2.

The image forming device 100 is a tandem-type multi-function peripheral (MFP) that has scanner, printer, and copier functions.

The image forming device 100 includes a paper feeder 103 in which sheets are stacked in a lowermost portion of a casing frame, above which is disposed a printer 102 including a main controller 111, imaging units 113Y, 113M, 113C, 113K, an intermediate transfer belt 112, and a fixing unit 114, above which is disposed an image reader 101 that reads images of documents and converts the images into image data composed of multi-value digital signals.

In each of the imaging units 113Y, 113M, 113C, 113K, a photosensitive drum is uniformly charged by a charging roller, exposed to light by an LED array, and an electrostatic latent image is formed on a surface of the photosensitive drum. The electrostatic latent images are each developed by a developer of a corresponding color, forming Y, M, C, K single color toner images on surfaces of corresponding photosensitive drums, then the toner images are sequentially transferred onto a surface of the intermediate transfer belt 112 by electrostatic action of primary transfer rollers disposed on a reverse side of the intermediate transfer belt 112.

A sheet is fed from a paper cassette of the paper feeder 103 in coordination with imaging operations of the imaging units 113Y, 113M, 113C, 113K. The sheet type of the sheet fed from the paper cassette is determined by a sensor unit 130 disposed along a feed path of the sheet. A result of the determination is used as a condition of image forming in the printer 102. A sheet that has passed through the sensor unit 130 is conveyed along a conveyance path to position where a secondary transfer roller 115 and a backup roller sandwich the intermediate transfer belt 112 (secondary transfer position), and at the secondary transfer position a Y, M, C, K color toner image on the intermediate transfer belt 112 is transferred to the sheet by electrostatic action of the secondary transfer roller 115 (secondary transfer). The sheet on which the Y, M, C, K color toner image is transferred is conveyed to the fixing unit 114.

The toner image on the surface of the sheet is fixed to the surface of the sheet by the fixing unit 114. After the sheet passes through the fixing unit 114, the sheet is discharged to a discharge tray.

The sensor unit 130 has the same configuration as the sensor unit 30 of Embodiment 1 (FIG. 5), the sensor unit 30a of Modification (1) (FIG. 8), or the sensor unit 30b of Modification (2) (FIG. 9). The sensor unit 130 determines sheet type.

The main controller 111 includes both the main controller 24 (FIG. 4) and the main controller 50 (FIG. 6) of Embodiment 1.

The light emitting element 31 of the sensor unit 130 emits light at wavelength 780 nm, and the light receiving unit 33 of the sensor unit 130 outputs a first signal indicating intensity of light passing through the sheet S. The calculator 53 of the main controller 111 calculates the first transmittance according to the first signal. The light emitting element 32 of the sensor unit 130 emits light at wavelength 1100 nm, and the light receiving unit 33 of the sensor unit 130 outputs a second signal indicating intensity of light passing through the sheet S. The calculator 53 of the main controller 111 calculates the second transmittance according to the second signal.

The calculator 53 calculates the ratio (=(second transmittance)/(first transmittance)), and the determiner 52 of the main controller 111 compares the calculated ratio to the first threshold. If the ratio is smaller than the first threshold, the controller 51 sets the sheet type to “A” (uncoated paper). If the ratio is equal to or greater than the first threshold, the controller 51 sets the sheet type to “B” (coated paper).

The main controller 111 sets an image forming condition according to the sheet type set, and executes image forming.

Thus, as per Embodiment 1, Embodiment 2 can determine sheet type.

### 10. Other Modifications

The present disclosure is described in terms of the Embodiments and Modifications above, but is not limited to the Embodiments and Modifications above.

(1) As described in the Embodiments and Modifications above, each sensor unit includes the light emitting element 31 that emits light at wavelength 780 nm and the light emitting element 32 that emits light at wavelength 1100 nm. Here, wavelength 780 nm and wavelength 1100 nm are discrete. However, limitation to this configuration is not intended.

Each sensor unit, in the wavelength band from 780 nm to 1100 nm, may include at least one light emitting element that emits light of a discrete wavelength other than 780 nm and 1100 nm (for example, 850 nm, 900 nm, 1000 nm). Here, each light emitting element emits light at the same intensity.

The light receiving element of each sensor unit receives light irradiated on a sheet from the light emitting elements and transmitted through the sheet.

For example, each sensor unit may include five light emitting elements, each emitting light at one of the wavelengths 780 nm, 850 nm, 900 nm, 1000 nm, and 1100 nm.

The light receiving element of each sensor unit receives transmitted light at the wavelengths 780 nm, 850 nm, 900 nm, 1000 nm, and 1100 nm, and from these wavelengths of transmitted light, transmittance T1, T2, T3, T4, and T5 are calculated, respectively.

Further, the calculator 53 may use five sets of coordinates of wavelength and transmittance (780, T1), (850, T2), (900, T3), (1000, T4), and (1100, T5) to calculate an approximate straight line based on the five coordinates, and may use slope of the approximate straight line as the slope of the transmittance curve.

In this way, the slope is calculated from transmittance at many wavelengths, and therefore accuracy of the calculated slope is improved over calculation from transmittance at two wavelengths.

(2) According to at least one embodiment, each device is a computer system comprising a microprocessor and a memory. The memory may store a controller computer program, and the microprocessor may operate according to the computer program.

Here, the computer program is a combination of instruction codes that indicate instructions to a computer in order to achieve defined functions.

Further, the computer program may be stored on a computer-readable storage medium such as a flexible disk, hard disk, optical disk, or semiconductor memory.

Further, the computer program may be transmitted via telecommunication lines, wireless or wired communication lines, a network such as the Internet, a data broadcast, or the like.

Further, the computer program may be executed by another independent computer system by transfer via recording on a storage medium or transfer via a network or the like.

(3) Any of the Embodiments and Modifications may be combined.

What is claimed is:

1. A sheet distinguishing device that determines sheet type, the sheet distinguishing device comprising:
a light emitter that irradiates a sheet with light at discrete wavelengths;
a light receiver that receives light from the sheet;
a calculator that obtains an intensity of light for each of the discrete wavelengths from the light received, and calculates a characteristic value with respect to a wavelength distribution of light intensity, based on the intensities obtained; and
a determiner that determines whether the sheet is a first type or a second type by using the characteristic value.

2. The sheet distinguishing device of claim 1, wherein
the light emitter emits light at each of the discrete wavelengths in a wavelength band from 760 nm to 1400 nm.

3. The sheet distinguishing device of claim 1, wherein
the light emitter comprises light emitting elements that each emit a different one of the discrete wavelengths of light.

4. The sheet distinguishing device of claim 1, wherein
the light receiver comprises light receiving elements that each receive a different one of the discrete wavelengths of light.

5. The sheet distinguishing device of claim 1, wherein
the first type is coated paper and the second type is uncoated paper, and
the determiner determines whether or not the characteristic value is in a defined range, determines that the sheet is the first type when the characteristic value is in the defined range, and determines that the sheet is the second type when the characteristic value is not in the defined range.

6. The sheet distinguishing device of claim 5, wherein
the calculator calculates a ratio of intensity of light at one wavelength among the discrete wavelengths to intensity of light at a shorter wavelength among the discrete wavelengths as the characteristic value,
the characteristic value being in the defined range corresponds to the ratio being equal to or greater than a defined threshold and the characteristic value not being in the defined range corresponds to the ratio being less than the defined threshold, and
the determiner compares the ratio to the defined threshold and determines that the sheet is coated paper if the ratio is equal to or greater than the defined threshold and determines that the sheet is uncoated paper if the ratio is less than the defined threshold.

7. The sheet distinguishing device of claim 5, wherein
the calculator calculates a slope based on at least a first light of a first wavelength among the discrete wavelengths and a second light of a second wavelength greater than the first wavelength among the discrete wavelengths, the slope being based on at least a ratio of a difference between intensity of the second light and intensity of the first light to a difference between the second wavelength and the first wavelength,
the characteristic value being in the defined range corresponds to the slope being equal to or greater than a defined threshold and the characteristic value not being in the defined range corresponds to the slope being less than the defined threshold, and
the determiner compares the slope to the defined threshold and determines that the sheet is coated paper if the slope is equal to or greater than the defined threshold and determines that the sheet is uncoated paper if the slope is less than the defined threshold.

8. The sheet distinguishing device of claim 5, further comprising
a gloss level detector that detects gloss level of the sheet, wherein
the determiner further compares the gloss level to a second threshold, and
upon determining that the sheet is coated paper, determines that the sheet is glossy paper with a gloss coating if the gloss level is equal to or greater than the second threshold and determines that the sheet is matte paper with a matte coating if the gloss level is less than the second threshold.

9. The sheet distinguishing device of claim 8, wherein
the determiner, upon determining that the sheet is uncoated paper, determines that the sheet is high quality paper if the gloss level is equal to or greater than the second threshold and determines that the sheet is plain paper if the gloss level is less than the second threshold.

10. The sheet distinguishing device of claim 5, further comprising
a thickness detector that detects thickness of the sheet, wherein
the calculator:
calculates a slope based on at least a first light of a first wavelength among the discrete wavelengths and a second light of a second wavelength greater than the first wavelength among the discrete wavelengths, the slope being based on at least a ratio of a difference between intensity of the second light and intensity of the first light to a difference between the second wavelength and the first wavelength; and
calculates a corrected slope by using the thickness to correct the slope, wherein
the corrected slope is the characteristic value,
the corrected slope being within a given range of a defined threshold corresponds to the characteristic value being in the defined range, the corrected slope not being within the given range of the defined threshold corresponds to the characteristic value not being in the defined range, and
the determiner determines whether or not the corrected slope is in the given range of the defined threshold, determines that the sheet is coated paper if the corrected slope is in the given range of the defined threshold, and determines that the sheet is uncoated paper if the corrected slope is not in the given range of the defined threshold.

11. The sheet distinguishing device of claim 5, further comprising
a thickness detector that detects thickness of the sheet, wherein
the calculator:
calculates a slope based on at least a first light of a first wavelength among the discrete wavelengths and a second light of a second wavelength greater than the first wavelength among the discrete wavelengths, the slope being based on at least a ratio of a difference between intensity of the second light and intensity of the first light to a difference between the second wavelength and the first wavelength, and
calculates a corrected threshold by using the thickness to correct a defined threshold, wherein
the slope being within a given range of the corrected threshold corresponds to the characteristic value being in the defined range, the slope not being within the given range of the corrected threshold corresponds to the characteristic value not being in the defined range, and
the determiner determines whether or not the slope is within the given range of the corrected threshold, determines that the sheet is coated paper if the slope is within the given range of the corrected threshold, and determines that the sheet is uncoated paper if the slope is not within the given range of the corrected threshold.

12. An image forming device that adjusts an image forming condition according to sheet type, the image forming device comprising:
a sheet distinguishing device that determines the sheet type, the sheet distinguishing device comprising:
a light emitter that irradiates a sheet with light at discrete wavelengths;
a light receiver that receives light from the sheet;
a calculator that obtains an intensity of light for each of the discrete wavelengths from the light received, and calculates a characteristic value with respect to a wavelength distribution of light intensity, based on the intensities obtained; and
a determiner that determines whether the sheet is a first type or a second type by using the characteristic value.

13. A sheet distinguishing method that determines sheet type of a sheet in a sheet distinguishing device comprising a light emitter that emits light at discrete wavelengths and a light receiver that receives light from the sheet, the sheet distinguishing method comprising:
obtaining an intensity of light for each of the discrete wavelengths from the light received and calculating characteristic value with respect to a wavelength distribution of light intensity, based on the intensities obtained; and
determining whether the sheet is a first type or a second type by using the characteristic value.

14. A non-transitory computer-readable storage medium storing a computer program for executing a control that determines sheet type of a sheet used in a sheet distinguishing device comprising a light emitter that emits light at discrete wavelengths and a light receiver that receives light from the sheet, the computer program comprising:
causing the sheet distinguishing device, which is a computer, to:
obtain an intensity of light for each of the discrete wavelengths from the light received and calculates a characteristic value with respect to a wavelength distribution of light intensity, based on the intensities obtained; and
determine whether the sheet is a first type or a second type by using the characteristic value.
